(19) United States
(12) Patent Application Publication
(10) Pub. No.: US 2007/0019525 A1
(43) Pub. Date: Jan. 25, 2007

(54) Optical disc drive and method of judging disc type thereof

(75) Inventors: Hsien-Yu Tseng, Taipei (TW); Cheng-Chung Ho, Taipei (TW)

Correspondence Address: RABIN & Berdo, PC, 1101 14TH STREET, NW, SUITE 500, WASHINGTON, DC, 20005, US

(73) Assignee: ASUSTek COMPUTER INC.

(21) Appl. No.: 11/487,337

(22) Filed: Jul. 17, 2006

(30) Foreign Application Priority Data
Jul. 22, 2005 (TW) 94124922

(51) Int. Cl. G11B 7/00

(52) U.S. Cl. 369/53.22

(57) ABSTRACT

A method of judging a type of a disc includes recording a first value of a SBAD signal generated by an optical pickup when a DVD laser beam is emitted to the disc, and judging whether the disc is DVD or CD according to the first value. If the disc is CD, the method further includes judging whether the disc has a read-only type or a non-read-only type according to the first value, recording a second value of the SBAD signal when a CD laser beam is emitted, calculating an absolute value of a difference between the first and second values, judging whether the disc is CD-R or CD-ROM according to the absolute value if the disc has the read-only type, and judging whether the disc is CD-RW or otherwise judging whether the disc is CD-R or CD-ROM according to the second value if the disc has the non-read-only type.

This application claims the benefit of Taiwan application Serial No. 94124922, filed Jul. 22, 2005, the subject matter of which is incorporated herein by reference.

### BACKGROUND OF THE INVENTION

1. Field of the Invention

The invention relates in general to an optical disc drive and a method of detecting a specification of a disc thereof, and more particularly to a DVD-ROM optical disc drive and a method of judging a disc type thereof.

2. Description of the Related Art

The applications of DVD (Digital Versatile Disc) have been merged into the human life deeply. In order to make the DVD optical disc drive be applied widely, the DVD optical disc drive has to support the DVD format disc, such as DVD-ROM, DVD-R/RW, DVD+R/RW, DVD-ROM DL (Dual Layer), DVD+R DL, DVD-R DL or the like), as well as the discs having other specifications, such as CD-ROM (Compact Disc Read-Only Memory, CD-ROM), CD-R (Compact Disc Recordable), CD-RW (Compact Disc Rewritable), and the like. The optical disc drive judges the type of the disc after the disc is placed therein, and then determines an accessing operation corresponding to the specification of the disc. Among the servo signals of the optical disc drive, a SBAD signal (Side Beam Added Signal), which is obtained by summating the signals D, E, F and G, is used to judge the type of the disc.

In order to judge whether the disc is a CD-ROM, a threshold value is needed with respect to the generated value D1. FIG. 1A is a distribution diagram showing values of SBAD signals generated in correspondence with various discs using a DVD laser beam. The diagram is produced by recording times and the values of the SBAD signals after the DVD laser beam is emitted to the various types of discs. For example, 20 CD-ROM discs may be chosen, and the values of the SBAD signals generated after the DVD laser beam is emitted to the discs and the times of generation are recorded. For example, the value of the SBAD signal of 0.5 is generated once, the value of the SBAD signal of 0.6 is generated twice, the value of the SBAD signal of 1.0 is generated three times, etc. Then, the relationships between the times and the values are plotted as shown in FIG. 1A. Thereafter, the relationships between those of the CD-R and the CD-RW are plotted as shown in FIG. 1A, and the distributions corresponding to various types of discs may be obtained.

The discs with the same specification do not have exactly the same property, but can generate the values of the SBAD signals that are converged in a zone. As shown in FIG. 1A, the curve Crom1 corresponding to the values of the SBAD signals generated when the DVD laser beam is emitted to the CD-ROM falls between the values V11 and V12. The curve Cr1 corresponding to the values of the SBAD signals generated when the DVD laser beam is emitted to the CD-R falls between the values V13 and V14. The curve Crw1 corresponding to the values of the SBAD signals generated when the DVD laser beam is emitted to the CD-RW falls between the values V15 and V16. Thus, it is possible to judge whether the disc is the CD-ROM by setting the threshold value of FIG. 1A between the values V11 and V14.

As shown in FIG. 1A, because the range for the CD-R is too close to the range for the CD-RW, the CD laser beam has to be emitted to the disc again for judgement if the disc is not the CD-ROM. FIG. 1B is a distribution diagram showing values of SBAD signals generated in correspondence with various discs using a CD laser beam. The curve Crom2 corresponding to the values of the SBAD signals generated when the CD laser beam is emitted to the CD-ROM falls between the values V21 and V22. The curve Cr2 corresponding to the values of the SBAD signals generated when the CD laser beam is emitted to the CD-R falls between the values V23 and V24. The curve Crw2 corresponding to the values of the SBAD signals generated when the CD laser beam is emitted to the CD-RW falls between the values V25 and V26. As shown in FIG. 1B, the ranges for the CD-RW and the CD-R are separated more clearly. Thus, it is possible to determine whether the disc is the CD-RW or the CD-R according to the zone in which the value for the disc falls.

However, FIGS. 1A and 1B are distribution diagrams showing the values of the SBAD signals under an ideal state. FIG. 1C is a distribution diagram showing values of SBAD signals generated in correspondence with various discs using a DVD laser beam under a nonideal state. Because the discs may have uneven qualities, the condition of the curve Cr3 may occur if the range corresponding to the SBAD signals is generated when the DVD laser beam is emitted to a CD-R having a higher reflectivity. Thus, the curve Cr3 and the curve Crom3 are partially overlapped with each other between the values V31 and V34. If the value of the SBAD signal corresponding to the disc falls between the values V31 and V34, the error judgement may be made and cannot be compensated even if the CD laser beam is used to judge again.

When the threshold value of the CD-R is being tested, errors may be caused because the intensity of the laser beam directly influences the intensity of the SBAD signal. As shown in the condition of FIG. 1 C, for example, when the threshold value of the CD-R is being set, the DVD laser beam has a higher power and thus causes the condition of the curve Cr3, and it is more difficult to set the threshold value.

### SUMMARY OF THE INVENTION

It is therefore an object of the invention to provide an optical disc drive and a method of judging a type of a disc thereof with a reduced uncertain factor and an enhanced precision of judgement.

The embodiment of the invention achieves the above-identified object by providing a method of judging a type of a disc using an optical pickup, which can generate a first laser beam for reading a DVD and a second laser beam for reading a CD. The method includes the steps of: recording a first value of a SBAD signal generated by the optical pickup after the disc reflects the first laser beam; judging whether the disc is the DVD or the CD according to the first value; and if the disc is the CD, performing the following steps. The following steps include: judging whether the disc is a read-only type disc or a non-read-only type disc according to the first value; recording a second value of the SBAD signal generated by the optical pickup after the disc reflects the second laser beam; calculating an absolute value of a difference between the first value and the second value; judging whether the disc is a CD-R or a CD-ROM according to the absolute value if the disc is judged as the read-only type disc; and judging whether the disc is a CD-RW according to the second value or otherwise judging whether the disc is the CD-R or the CD-ROM according to the absolute value if the disc is judged as the non-read-only type disc.

The embodiment of the invention also achieves the above-identified object by providing an optical disc drive for reading a disc. The optical disc drive includes an optical pickup and a processing unit. The optical pickup includes a first laser source, a second laser source and a photo detector. The first laser beam is used to read the DVD, and the second laser beam is used to read the CD. The disc reflects a beam emitted from the first laser source to generate a first reflected beam. The disc reflects a beam emitted from the second laser source to generate a second reflected beam. The photo detector receives the first reflected beam and thus generates a first value of the SBAD signal, and receives the second reflected beam and thus generates a second value of the SBAD signal. The processing unit judges whether the disc is the DVD or the CD according to the first value, and calculates an absolute value of a difference between the first value and the second value. If the disc is the CD, the processing unit judges whether the disc is a read-only type disc or a non-read-only type disc according to the first value. If the disc is the read-only type disc, the processing unit judges whether the disc is a CD-R or a CD-ROM according to the absolute value. If the disc is the non-read-only type disc, the processing unit judges whether the disc is a CD-RW according to the second value. If the disc is not the CD-RW, the processing unit judges whether the disc is the CD-R or the CD-ROM according to the absolute value. The first laser source and the second laser source may be laser diodes.

The embodiment of the invention also achieves the above-identified object by providing A method of judging a type of a disc using an optical pickup for generating a first laser beam to read a DVD and a second laser beam for reading a CD, the method comprising the steps of: recording a first value of a SBAD signal generated by the optical pickup after the disc reflects the first laser beam; recording a second value of the SBAD signal generated by the optical pickup after the disc reflects the second laser beam; calculating an absolute value of a difference between the first value and the second value; and judging the type of the disc according to the absolute value, the first value and the second value.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a distribution diagram showing values of SBAD signals generated in correspondence with various discs using a DVD laser beam.

FIG. 1B (Prior Art) is a distribution diagram showing values of SBAD signals generated in correspondence with various discs using a CD laser beam.

FIG. 1C (Prior Art) is a distribution diagram showing values of SBAD signals generated in correspondence with various discs using a DVD laser beam under a nonideal state.

FIG. 2 is a diagram showing the architecture of an optical disc drive according to a preferred embodiment of the invention.

FIGS. 3A-3B are flow charts showing a method of judging a specification of a disc according to the preferred embodiment of the invention.

FIG. 4 is a distribution diagram showing an absolute value of a difference between values of SBAD signals generated when a first laser beam and a second laser beam are emitted to the disc.

### DETAILED DESCRIPTION OF THE INVENTION

FIG. 2 is a diagram showing the architecture of an optical disc drive according to a preferred embodiment of the invention. Referring to FIG. 2, an optical disc drive 300 for reading a disc 350 includes an optical pickup 310 and a processing unit 320.

The optical pickup (or pick-up head) 310 can generate a first laser beam for reading a DVD, and a second laser beam for reading a CD. The optical pickup 310 includes a DVD laser diode 311, a CD laser diode 312 and a photo detector 315. The DVD laser diode 311 emits the first laser beam to the disc 350. The CD laser diode 312 emits the second laser beam to the disc 350. The photo detector 315 receives reflected laser beams, which are generated after the disc reflects the first laser beam and the second laser beam, and thus generates a SBAD signal.

The optical pickup 310 further includes an objective lens 313, a beam splitter 314, a collimator lens 316, a diffraction grating 317, a cylindrical lens 318 and a cylindrical lens 319 to form an optical path among the DVD laser diode 311, the CD laser diode 312, the disc 350 and the photo detector 315.

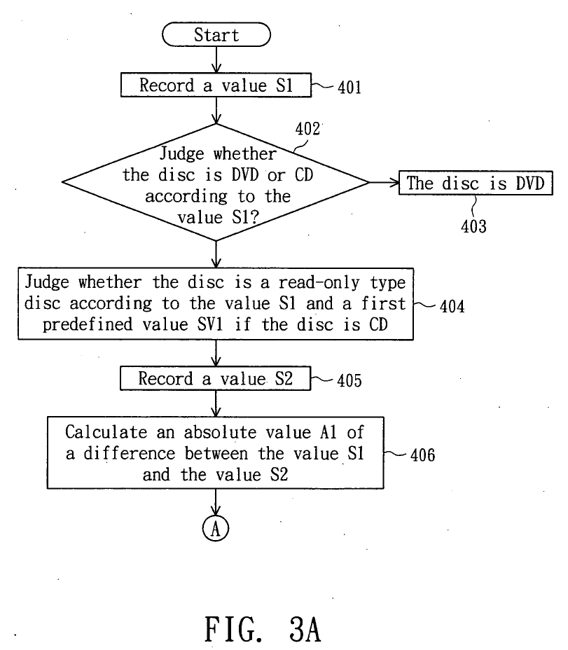

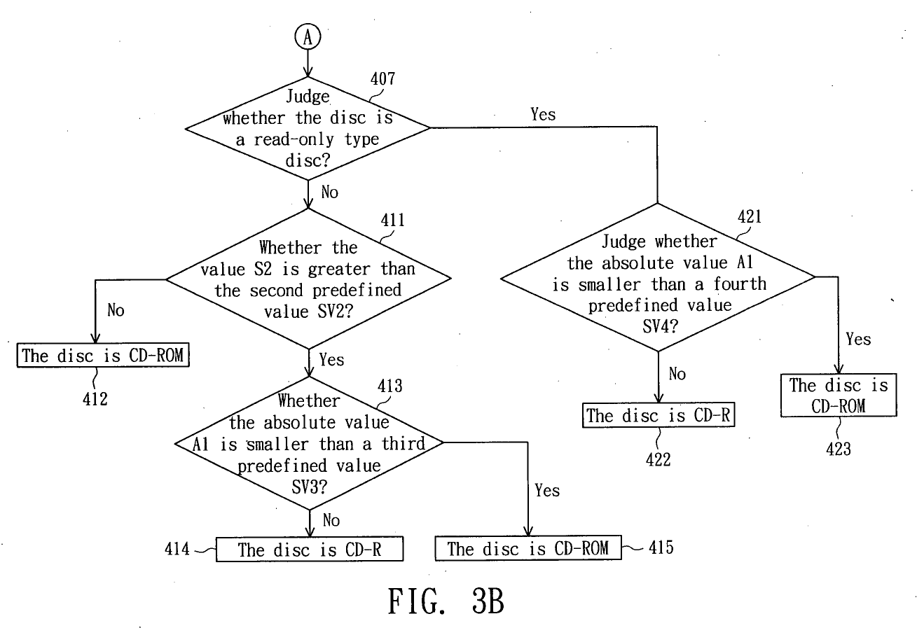

FIGS. 3A-3B are flow charts showing a method of judging a specification of a disc according to a preferred embodiment of the invention. First, step 401 records a value S1 of a SBAD signal generated by the optical pickup when the first laser beam is emitted to the disc. Next, step 402 judges whether the disc is a DVD or a CD according to the value S1. Step 403 judges the disc as the DVD. If the disc is the CD, step 404 judges whether the disc is a read-only type disc and records the disc by determining whether the value S1 is greater than a first predefined value SV1. If the value S1 is greater than the first predefined value SV1, the disc is the read-only type disc. On the contrary, the disc is a non-read-only type disc.

Then, step 405 records a value S2 of the SBAD signal generated by the optical pickup when the second laser beam is emitted to the disc 350. Thereafter, step 406 calculates an absolute value A1 of a difference between the value S1 and the value S2.

Then, step 407 judges whether the disc 350 is the read-only type disc according to the record of step 403. If the disc 350 is not the read-only type disc, step 411 judges whether the value S2 is greater than a second predefined value SV2. If the value S2 is not greater than the second predefined value SV2, step 412 ensures that the disc 350 is the CD-RW.

In step 411, the value S2 is greater than the second predefined value SV2. Thus, step 413 judges whether the absolute value A1 is smaller than a third predefined value SV3. If the absolute value A1 is not smaller than the third predefined value SV3, step 414 ensures that the disc is the CD-R. If the absolute value A1 is smaller than the third predefined value SV3, step 415 ensures that the disc is the CD-ROM.

If step 407 obtains that the disc 350 is the read-only type disc, step 421 judges whether the absolute value A1 is smaller than a fourth predefined value SV4. If the absolute value A1 is not smaller than the fourth predefined value SV4, step 422 ensures that the disc is the CD-R. If the absolute value A1 is smaller than the fourth predefined value SV4, step 423 ensures that the disc is the CD-ROM.

The sequence of steps 403 to 405 may be changed. It is possible to perform the test using the second laser beam and then the test using the first laser beam. For example, steps 403, 405 and 404 may be performed in sequence.

Step 405 calculates the absolute value A1 of the difference between the value S1 and the value S2. It is possible to eliminate the variation between the SBAD signals corresponding to the laser beams with different intensities according to the difference when the disc reflects the laser beams, which are emitted from laser diodes and have different intensities, so that the type of the disc may be judged more precisely. It is also possible to reduce the influence on the disc having a higher or a lower reflectivity.

It is obtained that the power of the second laser beam increases as the power of the first laser beam increases due to the property of the optical pickup. On the contrary, the power of the second laser beam decreases as the power of the first laser beam decreases. The threshold value for the discs with the same specification may be set according to the concept of the invention and this property. No matter what the power the first or second laser beam is, the values of the SBAD signals obtained after the disc reflects the second laser beam are subtracted from the values of the SBAD signals obtained after the disc reflects the first laser beam, and the variations caused by the too-large or too-small power of the laser beam can be reduced.

The value of the SBAD signal obtained after the disc having a higher reflectivity has reflected the first or second laser beam is larger. So, subtracting the values of the SBAD signals, which are obtained after the disc reflects the second laser beam, from the values of the SBAD signals, which are obtained after the disc reflects the first laser beam, can reduce the variation caused by the higher reflectivity as well as the variation caused by the lower reflectivity.

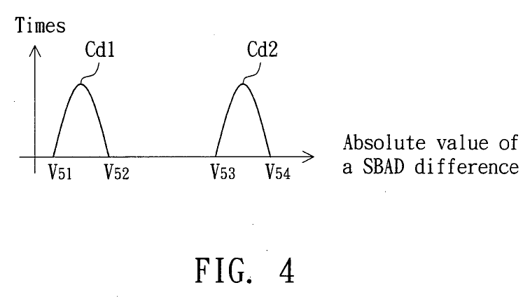

FIG. 4 is a distribution diagram showing an absolute value of a difference between values of SBAD signals generated when a first laser beam and a second laser beam are emitted to the disc. FIG. 4 is plotted by recording the times and the absolute values of the differences of the SBAD signals obtained after the disc has reflected the first laser beam and the second laser beam.

Curve Cd1 is a distribution curve of the absolute value of the difference between values of the SBAD signals for the CD-ROM and the CD-RW, and the range of the curve is between values V51 and V52. Curve Cd2 is a distribution curve of the absolute value of the difference between values of the SBAD signals for the CD-R, and the range of the curve is between values V53 and V54. The distribution curve of FIG. 4 is obtained by recording the absolute value of the difference between the values of the SBAD signals generated after the disc reflects the first laser beam and the second laser beam. So, it is possible to prevent the power of the laser beam from influencing the value of the SBAD signal.

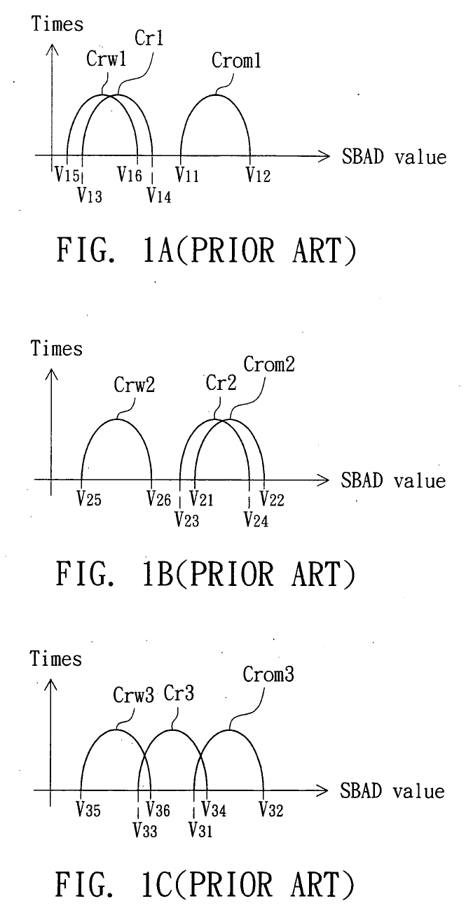

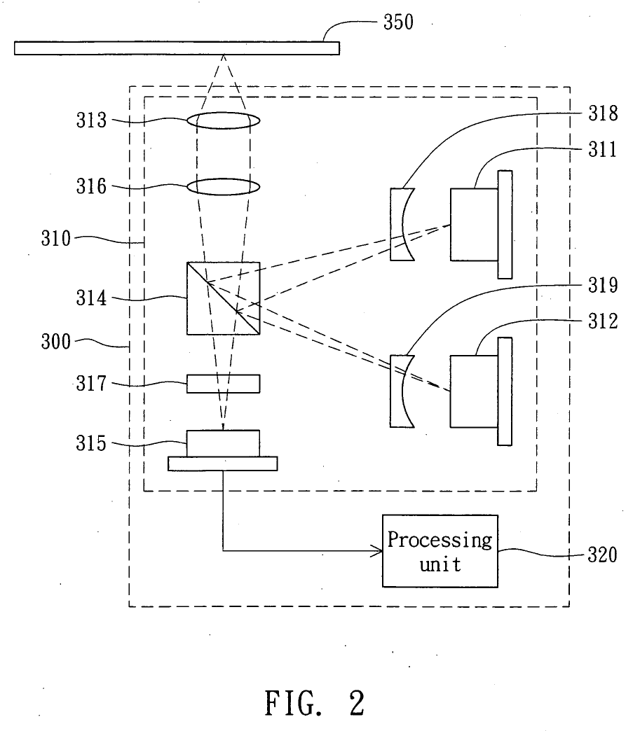

As shown in FIGS. 1A, 1B, 3 and 4, the first predefined value SV1 in step 403 may be the value V14 or V11 or range between the values V14 and V11 of FIG. 1A, for example. The second predefined value SV2 in step 411 may be the value V23 or V26 or range between the values V23 and V26 of FIG. 1B, for example. The third predefined value SV3 in step 413 and the fourth predefined value SV4 in step 421 may be the value V52 or V53 or range between the values V52 and V53 of FIG. 4, for example.

The optical disc drive and a method of judging a type of a disc thereof according to the embodiments of the invention utilize the absolute value of the difference between the values of the SBAD signals after the disc reflects the first laser beam and the second laser beam. So, the uncertain factor caused by the different properties of the discs or the different powers of the laser beams may be reduced, and the type of the disc may be judged more precisely.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of judging a type of a disc using an optical pickup, which can generate a first laser beam for reading a DVD and a second laser beam for reading a CD, the method comprising the steps of:
recording a first value of a SBAD signal generated by the optical pickup after the disc reflects the first laser beam;
judging whether the disc is the DVD or the CD according to the first value; and
if the disc is the CD, performing the steps of:
judging whether the disc is a read-only type disc or a non-read-only type disc according to the first value;
recording a second value of the SBAD signal generated by the optical pickup after the disc reflects the second laser beam;
calculating an absolute value of a difference between the first value and the second value;
judging whether the disc is a CD-R or a CD-ROM according to the absolute value if the disc is judged as the read-only type disc; and
judging whether the disc is a CD-RW according to the second value or otherwise judging whether the disc is the CD-R or the CD-ROM according to the absolute value if the disc is judged as the non-read-only type disc.

2. The method according to claim 1, wherein the process of judging whether the disc is the read-only type disc or the non-read-only type disc according to the first value comprises:
judging whether the first value is greater than a predefined value;
wherein the disc is the read-only type disc if the first value is greater than the predefined value, and the disc is the non-read-only type disc if the first value is not greater than the predefined value.

3. The method according to claim 1, wherein the process of judging whether the disc is the CD-R or the CD-ROM according to the absolute value comprises:
judging whether the absolute value is smaller than a predefined value;
wherein the disc is the CD-R if the absolute value is not smaller than the predefined value, and the disc is the CD-ROM if the absolute value is smaller than the predefined value.

4. The method according to claim 1, wherein the process of judging whether the disc is the CD-RW according to the second value comprises;
judging whether the second value is greater than a predefined value, wherein the disc is the CD-RW if the second value is not greater than the predefined value; and
if the second value is greater than the predefined value, performing the steps of:
judging whether the absolute value is smaller than a second predefined value;
the disc is the CD-ROM if the absolute value is smaller than the predefined value; and
the disc is the CD-R if the absolute value is not smaller than the predefined value.

5. An optical disc drive for reading a disc, the optical disc drive comprising:
an optical pickup, comprising:
a first laser source for generating a first laser beam to read a DVD, the disc reflecting the first laser beam to generate a first reflected beam;
a second laser source for generating a second laser beam to read a CD, the disc reflecting the second laser beam to generate a second reflected beam; and
a photo detector for receiving the first reflected beam to generate a first value of a SBAD signal, and receiving the second reflected beam to generate a second value of the SBAD signal; and
a processing unit for judging whether the disc is the DVD or the CD according to the first value, and calculating an absolute value of a difference between the first value and the second value;
wherein the processing unit judges whether the disc is a read-only type disc or a non-read-only type disc according to the first value if the disc is the CD;
wherein the processing unit judges whether the disc is a CD-R or a CD-ROM according to the absolute value if the disc is the read-only type disc;
wherein the processing unit judges whether the disc is a CD-RW according to the second value if the disc is the non-read-only type disc;
wherein the processing unit judges whether the disc is the CD-R or the CD-ROM according to the absolute value if the disc is not the CD-RW.

6. The optical disc drive according to claim 5, wherein the disc is the CD, the processing unit judges whether the first value is greater than a predefined value;
the disc is the read-only type disc if the first value is greater than the predefined value; and the disc is the non-read-only type disc if the first value is not greater than the predefined value.

7. The optical disc drive according to claim 5, wherein the disc is the read-only type disc, the processing unit judges whether the absolute value is smaller than a predefined value;
the disc is the CD-R if the absolute value is not smaller than the predefined value; and the disc is the CD-ROM if the absolute value is smaller than the predefined value.

8. The optical disc drive according to claim 5, wherein the disc is the non-read-only type disc, the processing unit also judges whether the second value is greater than a predefined value;
the disc is the CD-RW if the second value is not greater than the predefined value; and the processing unit judges whether the absolute value is smaller than a second predefined value if the second value is greater than the predefined value, and the disc is the CD-ROM if the absolute value is smaller than the second predefined value, or otherwise the disc is the CD-R.

9. A method of judging a type of a disc using an optical pickup for generating a first laser beam to read a DVD and a second laser beam for reading a CD, the method comprising the steps of:
recording a first value of a SBAD signal generated by the optical pickup after the disc reflects the first laser beam;
recording a second value of the SBAD signal generated by the optical pickup after the disc reflects the second laser beam;
calculating an absolute value of a difference between the first value and the second value; and
judging the type of the disc according to the absolute value, the first value and the second value.

10. The method according to claim 9, wherein the process of judging the type of the disc comprises:
judging whether the disc is a read-only type disc or a non-read-only type disc according to the first value;
judging whether the disc is a CD-ROM or a CD-R according to the absolute value if the disc is the read-only type disc; and
judging a specification of the disc according to the second value and the absolute value if the disc is the non-read-only type disc.

11. The method according to claim 10, wherein the process of judging the specification of the disc according to the second value and the absolute value comprises:
judging whether the disc is a CD-RW according to the second value; and
judging whether the disc is the CD-ROM or the CD-R according to the absolute value if the disc is not the CD-RW.
